(19) United States
(12) Patent Application Publication
(10) Pub. No.: US 2026/0169794 A1
(43) Pub. Date: Jun. 18, 2026

(54) APPARATUS AND METHOD FOR SCHEDULING ANALOG-DIGITAL ACCELERATORS BASED ON SOFTMAX FUNCTION VALUE

(71) Applicant: Electronics and Telecommunications Research Institute, Daejeon (KR)

(72) Inventors: Eun-Ji PAK, Daejeon (KR); Chang-Dae KIM, Daejeon (KR); Kwang-Won KOH, Daejeon (KR); Tae-Hoon KIM, Daejeon (KR); Yeon-Jeong JEONG, Daejeon (KR); Kang-Ho KIM, Daejeon (KR)

(73) Assignee: Electronics and Telecommunications Research Institute, Daejeon (KR)

(21) Appl. No.: 19/226,430

(22) Filed: Jun. 3, 2025

(30) Foreign Application Priority Data
Dec. 16, 2024 (KR) 10-2024-0186717

(51) Int. Cl. G06F 9/48; G06F 9/50

(52) U.S. Cl. CPC G06F 9/4881; G06F 9/5027

(57) ABSTRACT

Disclosed herein is an apparatus and method for scheduling analog-digital accelerators based on a softmax function value. The method may include performing an operation on input data using an analog accelerator, calculating a confidence score of the result of the operation performed using the analog accelerator based on softmax function values for the result of the operation performed using the analog accelerator, determining whether to perform the operation again on the input data using a digital accelerator depending on the confidence score of the result of the operation performed using the analog accelerator, and modifying the result of the operation performed using the analog accelerator by performing the operation again on the input data using the digital accelerator when it is determined to perform the operation again.

### CROSS REFERENCE TO RELATED APPLICATION

This application claims the benefit of Korean Patent Application No. 10-2024-0186717, filed Dec. 16, 2024, which is hereby incorporated by reference in its entirety into this application.

### BACKGROUND OF THE INVENTION

### 1. Technical Field

The disclosed embodiment relates to operation scheduling technology in a computing system including an analog accelerator and a digital accelerator.

### 2. Description of the Related Art

An analog accelerator is technology that utilizes memory cells, conventionally used only for data storage, as computing devices. It is mainly configured based on next-generation nonvolatile memory and is also referred to as terms such as Analog Processing In Memory (Analog PIM), Computing In Memory (CIM), and the like. Such an analog accelerator has superior computational performance and energy efficiency compared to a digital accelerator.

The operations of analog accelerators may substitute matrix-vector multiplication (MVM) operations, which are most frequently used for AI operations. MVM operations are frequently used in artificial neural network models and correspond to operations for computing an output vector by multiplying an input vector by a weight matrix.

When these operations are performed using analog computing memory, multiple MVM operations can be performed simultaneously, so computing speed much faster than that of digital accelerators and high power-efficiency may be gained. Also, because an operation is performed directly where data is stored, memory bandwidth bottlenecks may be alleviated. As a result, analog accelerators are attracting attention as technology for AI operations and may also be used in various fields that need MVM operations.

Although they are superior in computational performance and energy efficiency compared to digital accelerators, analog accelerators have limitations in being applied in practice because computation errors may be caused due to non-idealities thereof.

### SUMMARY OF THE INVENTION

An object of the disclosed embodiment is to prevent computation errors that are caused due to the non-idealities of AI computation through an analog accelerator having superior computational performance and energy efficiency.

Another object of the disclosed embodiment is to compensate for computation errors of an analog accelerator using a digital accelerator while minimizing the use of the digital accelerator, thereby maximizing the utilization of the analog accelerator, which has superior performance and energy efficiency.

A method for scheduling analog-digital accelerators based on a softmax function value according to an embodiment may include performing an operation on input data using an analog accelerator, calculating a confidence score of a result of the operation performed using the analog accelerator based on softmax function values for the result of the operation performed using the analog accelerator, determining whether to perform the operation again on the input data using a digital accelerator depending on the confidence score of the result of the operation performed using the analog accelerator, and modifying the result of the operation performed using the analog accelerator by performing the operation again on the input data using the digital accelerator when it is determined to perform the operation again.

Here, the confidence score may be a difference between a first value that is the largest of the softmax function values and a second value that is the second largest of the softmax function values.

Here, determining whether to perform the operation again may include determining whether the calculated confidence score is less than a predetermined lower percentile in an overall confidence score distribution.

Here, determining whether the calculated confidence score is less than the predetermined lower percentile may include calculating a histogram bin including the calculated confidence score, calculating the sum of the total number of confidence scores included in histogram bins with confidence scores lower than confidence scores within the calculated histogram bin and a value randomly selected between 0 and the count of the calculated histogram bin based on the count of the calculated histogram bin, and determining whether the percentile of the sum in the overall confidence score distribution is less than the predetermined lower percentile in the overall confidence score distribution.

Here, the confidence score may be cumulatively recorded in a histogram each time an operation is performed using the analog accelerator.

A method for scheduling analog-digital accelerators based on a softmax function value according to an embodiment may include a sampling phase for determining a threshold for a confidence score in order to determine whether to modify an analog operation result based on a result of collecting confidence scores for operations performed on a predetermined number of pieces of input data using an analog accelerator; and an execution phase for scheduling the analog accelerator and a digital accelerator based on a result of comparing the threshold with the confidence score calculated based on softmax function values for results of the operations performed on the pieces of input data using the analog accelerator.

Here, the confidence score may be a difference between a first value that is the largest of the softmax function values and a second value that is the second largest of the softmax function values.

Here, the sampling phase may include performing operations on a predetermined number of pieces of sample input data using both the analog accelerator and the digital accelerator and determining the threshold using confidence scores of results of the operations performed using the analog accelerator when the results of the operations performed using the analog accelerator are different from results of the operations performed using the digital accelerator.

Here, determining the threshold may comprise setting the threshold to 0 when all the results of the operations performed using the analog accelerator are identical to the results of the operations performed using the digital accelerator.

Here, the execution phase may include performing the operation on the input data using the analog accelerator, calculating the confidence score of the result of the operation performed using the analog accelerator based on the softmax function values for the result of the operation performed using the analog accelerator, determining whether to perform the operation again on the input data using the digital accelerator depending on whether the confidence score of the result of the operations performed using the analog accelerator is equal to or less than the threshold, and modifying the result of the operation performed using the analog accelerator by performing the operation again on the input data using the digital accelerator when it is determined to perform the operation again.

Here, the sampling phase and the execution phase may be alternately performed repeatedly, and determining the threshold may comprise reflecting a threshold calculated in a previous sampling phase at a predetermined ratio.

An apparatus for scheduling analog-digital accelerators based on a softmax function value according to an embodiment includes an analog accelerator, a digital accelerator, and a scheduler for controlling an operation for an artificial neural network model to be performed using one of the analog accelerator and the digital accelerator, and the scheduler may calculate a confidence score of a result of an operation performed on input data using the analog accelerator based on softmax function values for the result of the operation performed using the analog accelerator, determine whether to perform the operation again on the input data using the digital accelerator depending on the confidence score of the result of the operation performed using the analog accelerator, and modify, when it is determined to perform the operation again, the result of the operation performed using the analog accelerator by performing the operation again on the input data using the digital accelerator.

Here, the confidence score may be a difference between a first value that is the largest of the softmax function values and a second value that is the second largest of the softmax function values.

Here, when determining whether to perform the operation again, the scheduler may determine whether the calculated confidence score is less than a predetermined lower percentile in an overall confidence score distribution.

Here, when determining whether the calculated confidence score is less than the predetermined lower percentile, the scheduler may calculate a histogram bin including the calculated confidence score, calculate the sum of the total number of confidence scores included in histogram bins with confidence scores lower than confidence scores within the calculated histogram bin and a value randomly selected between 0 and the count of the calculated histogram bin based on the count of the calculated histogram bin, and determine whether a percentile of the sum is less than the predetermined lower percentile in the overall confidence score distribution.

Here, the confidence score may be cumulatively recorded in a histogram each time an operation is performed using the analog accelerator.

Here, the scheduler may set in advance a threshold of the confidence score for determining whether to modify the result of the operation performed using the analog accelerator based on a result of collecting confidence scores for results of operations performed on a predetermined number of pieces of sample input data using the analog accelerator and may determine whether to perform the operation again on the input data using the digital accelerator based on the threshold set in advance.

Here, the scheduler may perform the operations on the predetermined number of pieces of sample input data using both the analog accelerator and the digital accelerator and set the threshold using the confidence scores of the results of the operations performed using the analog accelerator when the results of the operations performed using the analog accelerator are different from results of the operations performed using the digital accelerator.

Here, the scheduler may set the threshold to 0 when all the results of the operations performed using the analog accelerator are identical to the results of the operations performed using the digital accelerator.

Here, the scheduler may set the threshold at predetermined intervals and reflect a previously calculated threshold at a predetermined ratio.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a structural diagram of an analog accelerator;

FIG. 2 is a schematic block diagram of a computing system to which an embodiment is applied;

FIG. 3 is a flowchart for explaining a method for scheduling analog-digital accelerators based on a softmax function value according to an embodiment;

FIG. 4 is a flowchart for explaining a method for scheduling analog-digital accelerators based on a softmax function value according to another embodiment;

FIG. 5 is a flowchart for explaining a method for scheduling analog-digital accelerators based on a softmax function value according to a further embodiment;

FIG. 6 is an exemplary view illustrating the performance result of a scheduling method when a digital accelerator usage rate is preset according to another embodiment; and

FIG. 7 is an exemplary view illustrating the performance result of a method of determining criteria for the use of a digital accelerator based on sampling and performing scheduling according to a further embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

FIG. 1 is a structural diagram of an analog accelerator.

Referring to FIG. 1, each memory cell (element) of an analog accelerator may store specific information depending on the state of the material that stores data.

When a specific voltage is applied to a Word Line (WL) corresponding to a row in FIG. 1 after storing G, which is a value corresponding to conductance proportional to a data value, in each memory cell, current proportional to the applied voltage and the conductance value of the memory cell flows in the memory cell.

Here, the value of the current flowing in each Bit Line (BL) corresponding to a column in FIG. 1 becomes the sum of the currents flowing in all the memory cells included in the corresponding column.

For example, the current I₁ flowing in the first BL in FIG. 1 may be a value corresponding to

$${\sum }_{i = 1}^{n} ( {G}_{1 i} \times {V}_{i} ) .$$

This principle may substitute for matrix-vector multiplication (MVM) operations, which are most commonly used for AI operations. The MVM operations are commonly used in artificial neural network models and correspond to operations for computing an output vector by multiplying an input vector by a weight matrix.

In order to use analog computing memory to perform this operation, the weight matrix is stored in each memory cell as a conductance value and the input vector is applied to word lines (WLs) as voltages. Then, the output vector may be immediately obtained by reading the value of the current flowing in each bit line (BL). Because this operation method enables multiple MVM operations to be performed simultaneously, the computing speed is much faster than that of a digital accelerator, and very high power-efficiency may be obtained. Also, because operation is performed directly where data is stored, memory bandwidth bottlenecks may be alleviated. Therefore, analog accelerators are attracting attention as technology for AI operations and may also be used in various fields that need MVM operations.

Although they are superior in computational performance and energy efficiency compared to digital accelerators, analog accelerators have limitations in being applied in practice because computation errors may be caused due to non-idealities thereof.

Here, the computation errors may be caused by various factors, and the cases in which computation errors occur in the process of performing an MVM operation for executing an AI model may be as follows.

First, when input data is converted into voltages, noise may occur during the conversion process, which may cause errors in the input data values.

Also, a weight value needs to be converted into a conductance level before being stored in each memory cell, but it is difficult to minutely adjust the conductance level, so noise may occur. Furthermore, the stored conductance level continuously changes over time when multiple read/write operations are performed or even when no operation is performed.

In addition, the operation result exists in the form of current, but when the current value is converted into output data, conversion errors or noise attributable to data precision constraints may cause computation errors.

Meanwhile, the softmax function is one of activation functions used for multiclass classification and is a function used to calculate the probability that the result of an AI operation corresponds to each class.

The softmax function normalizes the input values to values in the range [0,1], and the sum of all output values is 1. Because of these characteristics, the softmax function is often used in the final layer of an AI neural network and is useful when it is necessary to select one of multiple classes.

The result of the softmax function includes as many output values as the number of classes into which classification is to be performed, and the class corresponding to the largest output value is selected.

For class classification for image recognition or the like, the softmax function receives the result of the final layer of an AI neural network and computes and outputs the probability that the result corresponds to each class.

In addition, the softmax function may also be used to generate an attention score in large language models. Through this process, AI models may highlight contextually important information and suppress information with low importance. In this case, the softmax function value may be computed in the intermediate layer of the AI neural network.

Here, the greater the difference between the largest value (top 1, referred to as the “first value” hereinafter) and the second largest value (top 2, referred to as the “second value” hereinafter) of the softmax function values, the higher the probability that the operation result has high accuracy. That is, as the difference between the two values is greater, there is more confidence in selecting the class corresponding to top 1.

Therefore, in an embodiment, the softmax function value is used to determine whether the result of an operation performed on input data using an analog accelerator is reliable.

That is, an embodiment proposes a method for determining the reliability of a result of an operation performed using an analog accelerator based on the softmax function value and scheduling the analog accelerator and a digital accelerator based on the determined reliability.

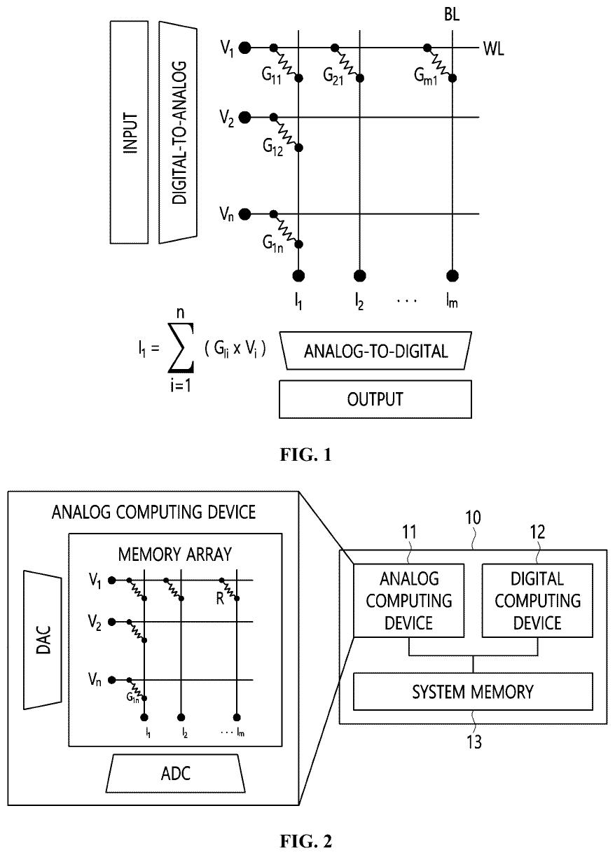

FIG. 2 is a schematic block diagram of a computing system to which an embodiment is applied.

Referring to FIG. 2, the computing system 10 to which an embodiment is applied may include an analog computing device 11, a digital computing device 12, and system memory 13.

These days, computing systems are often implemented by integrating various hardware devices, such as CPUs, GPUs, NPUs, DPUs, etc., into a single system. In particular, analog accelerators and digital accelerators may complement each other when performing operations.

Therefore, an embodiment intends to construct a system capable of utilizing all the advantages of the analog accelerator 11 and the digital accelerator 12 by compensating for errors in computation results of the analog accelerator 11, which are the disadvantage of the analog accelerator 11, by using the digital accelerator 12 while taking advantage of high computational performance and energy efficiency of the analog accelerator 11.

The analog accelerator 11 may target accelerators that are capable of performing operations within memory cells themselves as described above, and the digital accelerator may target any hardware capable of performing AI operations, such as CPUs, GPUs, NPUs, and the like.

In the computing system 10, the method for scheduling analog-digital accelerators based on a softmax function value may be performed.

Therefore, a scheduler (not illustrated) for performing the method for scheduling analog-digital accelerators based on a softmax function value may be provided in the computing system 10.

The scheduler may be a program or processing instructions stored in the system memory 13 or separately configured external memory, and may be executed by any one of various hardware devices capable of being separately configured, including the analog accelerator 11 and the digital accelerator 12.

The method for scheduling the analog accelerator 11 and the digital accelerator 12, which is performed in the above-described computing system, may have various embodiments.

First, according to an embodiment, the accuracy of the result of an operation by the analog accelerator may be determined based on a softmax function value, and the operation result may be compensated for using the digital accelerator.

According to another embodiment, the analog accelerator 11 and the digital accelerator 12 may be scheduled based on a preset digital accelerator usage rate.

According to a further embodiment, criteria for using the digital accelerator may be determined based on sampling of operation results, and the analog accelerator 11 and the digital accelerator 12 may be scheduled based on the determined criteria for the use of the digital accelerator.

First, the method for determining the accuracy of the result of an operation by the analog accelerator based on a softmax function value and compensating for the operation result using the digital accelerator according to an embodiment will be described below.

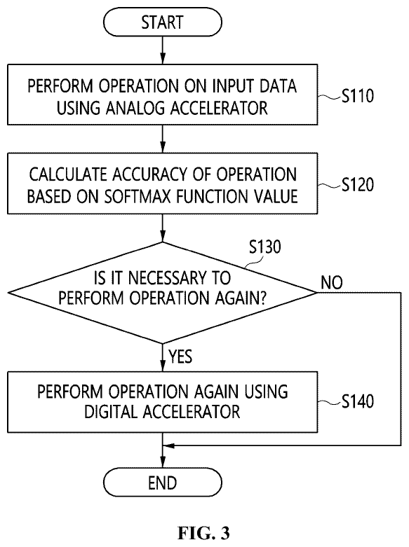

FIG. 3 is a flowchart for explaining a method for scheduling analog-digital accelerators based on a softmax function value according to an embodiment.

Referring to FIG. 3, the method for scheduling analog-digital accelerators based on a softmax function value according to an embodiment may include performing an operation on input data using an analog accelerator at step S110, calculating a confidence score of the result of the operation performed using the analog accelerator based on softmax function values for the result of the operation performed using the analog accelerator at step S120, determining whether to perform the operation again on the input data using a digital accelerator depending on the confidence score of the result of the operation performed using the analog accelerator at step S130, and modifying the result of the operation performed using the analog accelerator by performing the operation again on the input data using the digital accelerator at step S140 when it is determined to perform the operation again.

At the step (S120) of calculating the confidence score according to an embodiment, the confidence score for determining whether the result of the operation performed using the analog accelerator is accurate is calculated using softmax function values. This is because the softmax function values are related to the accuracy of the result value of an AI operation.

That is, when the first value (top 1) of the softmax function values is high, the probability that the result is correct increases. For example, assuming that an AI neural network selects one of four classes, when the softmax function values are [0.7, 0.1, 0.1, 0.1], the neural network selects class 1 with confidence corresponding to a probability of 0.7, and when the result values are [0.4, 0.35, 0.15, 0.1], the neural network selects class 1 with confidence corresponding to a probability of 0.4.

Also, in the latter case, the probability of selecting class 2 is 0.35, which means that the difference in the probability of the neural network selecting any one of the two classes is not significant. Accordingly, when top 1 of the softmax function values is large, the neural network selects the class with confidence, and the probability that the result is correct naturally increases.

In particular, the greater the difference between top 1 and top 2, i.e., the difference between the largest softmax function value and the second largest softmax function value, the higher the confidence in the result corresponding to top 1.

Therefore, the confidence score according to an embodiment may be defined as the difference between the first value (top 1), which is the largest of the softmax function values, and the second value (top 2), which is the second largest of the softmax function values.

Meanwhile, at the step (S130) of determining whether to perform the operation again according to an embodiment, when the confidence score is high, the result of the operation performed using the analog accelerator can be trusted. Accordingly, it is determined at step S130 that there is no need to perform the operation again using the digital accelerator, and the result of the operation by the analog accelerator is used.

Conversely, at the step (S130) of determining whether to perform the operation again according to an embodiment, when the confidence score is not high enough, the result of the operation performed using the analog accelerator cannot be trusted, so it is determined that it is necessary to perform the operation again using the digital accelerator.

Accordingly, at the step (S140) of modifying the result of the operation performed using the analog accelerator, the operation is performed again on the same input data using the digital accelerator, and the newly computed result is used, whereby the operation error of the analog accelerator may be corrected.

Here, because the analog accelerator theoretically has approximately 1,000 times the computational performance and energy efficiency compared to the digital accelerator, operations using the analog accelerator are significantly faster than those using the digital accelerator. Therefore, additional time and energy consumed for attempting an operation using the analog accelerator each time do not need to be factored into the computational load.

Also, although the result value of the softmax function may have an error due to the non-idealities of the analog accelerator, the effect of the error may be minimized because the difference between the two values is calculated, instead of using a single value.

In other words, if the difference between top 1 and top 2 is large when the operation is performed using the digital accelerator with high accuracy, the difference between top 1 and top 2 is still large even though the non-idealities are reflected due to the operation using the analog accelerator. Therefore, there is no need to consider the influence of the non-idealities when using the confidence score.

Next, a method for scheduling an analog accelerator and a digital accelerator based on a preset digital accelerator usage rate (digital rate, α %) according to another embodiment will be described below.

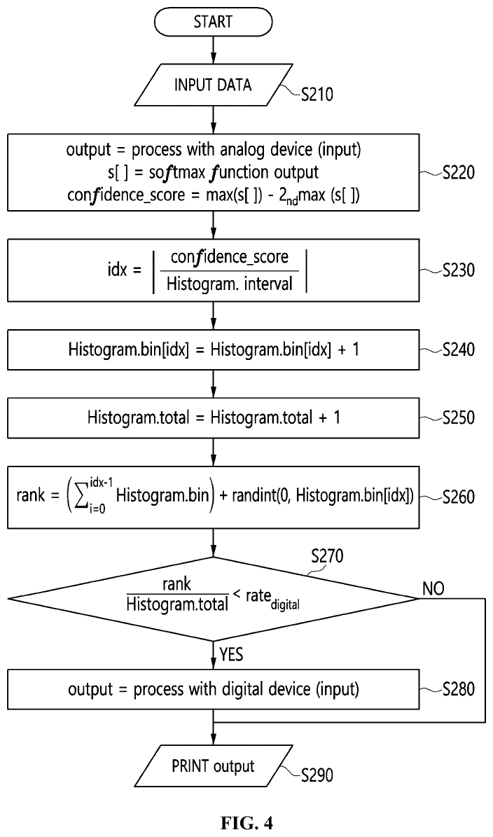

FIG. 4 is a flowchart for explaining a method for scheduling analog-digital accelerators based on a softmax function value according to another embodiment.

Referring to FIG. 4, the method for scheduling analog-digital accelerators based on a softmax function value according to another embodiment may include performing an operation on input data using an analog accelerator at steps S210 to S220, calculating a confidence score of the result of the operation performed using the analog accelerator based on softmax function values for the result of the operation performed using the analog accelerator at step S220, and determining whether to perform the operation again on the input data using a digital accelerator depending on the confidence score of the result of the operation performed using the analog accelerator at steps S230 to S270, and modifying the result of the operation performed using the analog accelerator by performing the operation again on the input data using the digital accelerator at step S280 when it is determined to perform the operation again.

First, when data is input at step S210, an operation is performed on the input data using the analog accelerator, after which a confidence score is calculated at step S220.

Specifically, the softmax function result value (s[ ]) is calculated for the output of the operation performed on the input data using the analog accelerator. Subsequently, the confidence score that is the difference between a first value (top 1) (max (s[ ])), which is the largest of the softmax function values, and a second value (top 2) (2_{nd}max(s[ ])), which is the second largest of the softmax function values, is calculated.

Here, the steps (S230 to S270) of determining whether to perform the operation again according to another embodiment may include determining whether the calculated confidence score is less than a predetermined lower percentile (α %) in the overall confidence score distribution.

Specifically, determining whether the calculated confidence score is less than the predetermined lower percentile (α %) may include calculating a histogram bin including the calculated confidence score at step S230, adding the total number of confidence scores included in histogram bins with confidence scores lower than confidence scores within the calculated histogram bin and a value randomly selected between 0 and the count of the calculated histogram bin based on the count of the calculated histogram bin at step S260, and determining whether the percentile of the addition result is less than the predetermined lower percentile in the overall confidence score distribution at step S270.

That is, the position (idx) of the histogram bin including the currently calculated confidence score is calculated at step S230.

Here, the overall confidence score distribution is recorded in the form of a histogram, and each time an operation is performed using the analog accelerator, the confidence score may be cumulatively recorded in the histogram at steps S240 to S250.

Then, the total number of confidence scores included in bins with confidence scores lower than confidence scores of the corresponding bin is calculated, and based on the count of the current bin, a value between 0 and the count of the current bin is randomly generated and added at step S260.

Then, whether the percentile (rank) of the value calculated at step S260 is less than a predetermined lower percentile (rate_{digital}), α %, in the overall confidence score distribution is determined at step S270.

Then, when the calculated confidence score corresponds to the lower α % of the overall confidence score distribution, the operation result is modified at step S280 by performing the operation again using the digital accelerator.

In this manner, the digital accelerator usage rate may be maintained at α %.

Meanwhile, the precision of the histogram, which is usually determined by the number of bins, may be set by a user. Here, when the number of bins increases, a fine-grained probability distribution may be recorded, but more memory space is required for storing the histogram, so this may be considered when setting the number of bins.

For example, when confidence scores ranging from 0 to 1 are recorded in the form of a histogram, if the confidence scores are sorted into ten histogram bins, the data may be recorded by being sorted into ten bins, which are 0˜0.1, 0.1˜0.2, . . . , 0.9˜1.

Here, performance evaluation is performed for the method for scheduling analog-digital accelerators based on a softmax function value according to an embodiment after sorting confidence scores into bins with an interval of 10, 20, and 50. When various kinds of image classification AI models are executed, it is confirmed that there is no significant difference in performance in the cases where the interval of bins is set to 10, 20, and 50 when the scheduling method is applied.

Finally, according to a further embodiment, criteria for using a digital accelerator may be determined based on sampling of the operation results, and scheduling may be performed.

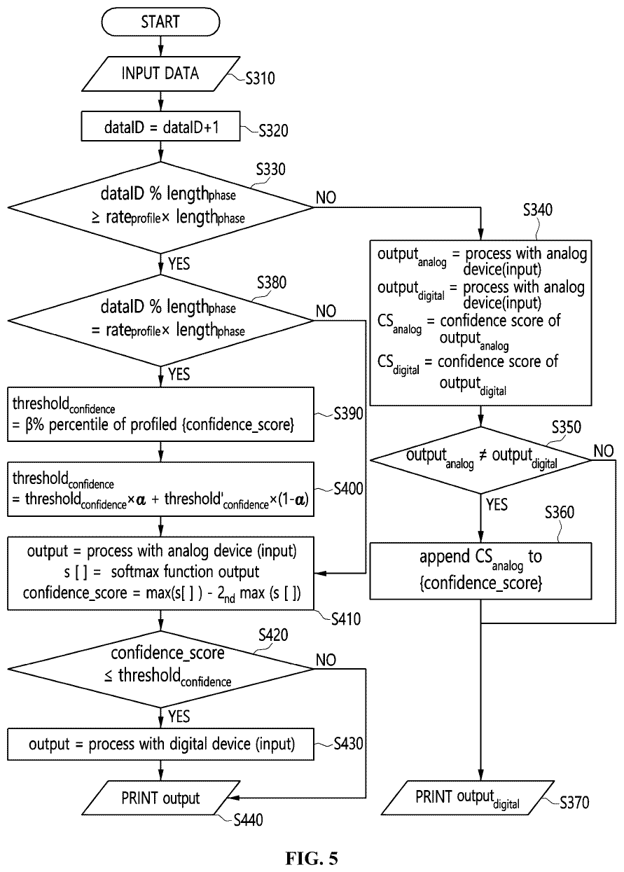

FIG. 5 is a flowchart for explaining a method for scheduling analog-digital accelerators based on a softmax function value according to a further embodiment.

Referring to FIG. 5, the method for scheduling analog-digital accelerators based on a softmax function value according to a further embodiment may include a sampling phase (S310 to S400) for determining a threshold of a confidence score for determining whether to modify an analog operation result based on a result of collecting confidence scores for the result of operations performed on a predetermined number of pieces of input data using an analog accelerator and an execution phase (S310 to S330, S380, and S410 to S440) for scheduling the analog accelerator and a digital accelerator based on a result of comparing the confidence score, calculated based on softmax function values for the result of the operations performed on the input data using the analog accelerator, with the threshold.

Here, the sampling phase (S310 to S400) may include performing operations on a predetermined number of pieces of sample input data using both the analog accelerator and the digital accelerator at steps S310 to S340 and determining the threshold using the confidence score of the result of the operation performed using the analog accelerator when the result of the operation performed using the analog accelerator differs from the result of the operation performed using the digital accelerator at steps S350 to S400.

That is, when the result of the operation using the analog accelerator differs from the result of the operation using the digital accelerator at step S350, it is more likely that the result of the operation using the digital accelerator is correct and that the result of the operation using the analog accelerator is incorrect. In this case, the confidence score is stored at step S360, and it may be used later when a reference threshold based on which the result of the operation using the analog accelerator will be corrected is calculated at step S390.

Here, at step S390, the threshold may be determined when the sampling phase ends. That is, determining the threshold may be performed when the number of pieces of input data is equal to the preset number of pieces of sample input data at step S380.

Here, the threshold may be set to the maximum value, the value corresponding to the 90% ile, the value corresponding to the 70% ile, or the like based on the confidence scores recorded so far by considering the AI model to be executed and system conditions.

That is, the threshold may be determined by considering both computational accuracy and computational efficiency. This is because, when the threshold is set too low, the opportunity to modify the operation result of the analog accelerator using the digital accelerator is decreased, which may lower computational accuracy. When the threshold is set too high, the digital accelerator is more frequently used, and the computational efficiency of the analog accelerator cannot be sufficiently utilized, which may reduce the computational efficiency of the entire system.

Here, at the step (S390) of determining the threshold, when the results of the operations using the analog accelerator are identical to the results of the operations using the digital accelerator, the threshold may be set to 0. That is, when the results of the operations using the analog accelerator are identical to the results of the operations using the digital accelerator, there is no need to modify the operation results using the digital accelerator. Therefore, the threshold is set to 0 such that all operations are performed using the analog accelerator.

Meanwhile, the sampling phase and the execution phase are alternately performed repeatedly, and the threshold calculated in the previous sampling phase may be reflected at a predetermined ratio at step S400.

That is, sampling may be periodically performed. When considering a single interval including the sampling interval and the execution interval, this interval may be repeatedly executed.

Therefore, according to an embodiment, the length of the repetition interval is determined first, and the sampling ratio is determined. For example, when the length of the repetition interval is set to 100, the sampling interval and the execution interval are collectively considered as a single repetition interval, and the number of pieces of data to be processed within this interval becomes 100.

Here, if the sampling ratio is 10%, the sampling phase is performed as described above when processing the first 10 pieces of data. Then, when the sampling interval ends, the threshold is set based on the pieces of data accumulated so far. Subsequently, when processing the next 90 pieces of data, the execution phase is performed as described above.

Here, the length of the interval and the sampling ratio are configurable values. When the embodiment is applied in the state in which the sampling ratio is set to 5%, 10%, 15%, and 20%, the experiment result shows that the sampling ratio of 5% is sufficient to determine an appropriate threshold value.

Also, when the sampling ratio increases, the sampling interval becomes longer, and because both the analog accelerator and the digital accelerator are used in the sampling interval, the usage ratio of the digital accelerator increases due to sampling. Therefore, it is necessary to set the sampling ratio to a value that is not too high.

Meanwhile, the execution phase may include performing an operation on input data using the analog accelerator at step S410, calculating a confidence score of the result of the operation performed using the analog accelerator based on softmax function values for the result of the operation performed using the analog accelerator at step S410, determining whether to perform the operation again on the input data using the digital accelerator depending on whether the confidence score of the result of the operation performed using the analog accelerator is equal to or less than the threshold at step S420, and modifying the result of the operation performed using the analog accelerator by performing the operation again on the input data using the digital accelerator at step S430 when it is determined to perform the operation again.

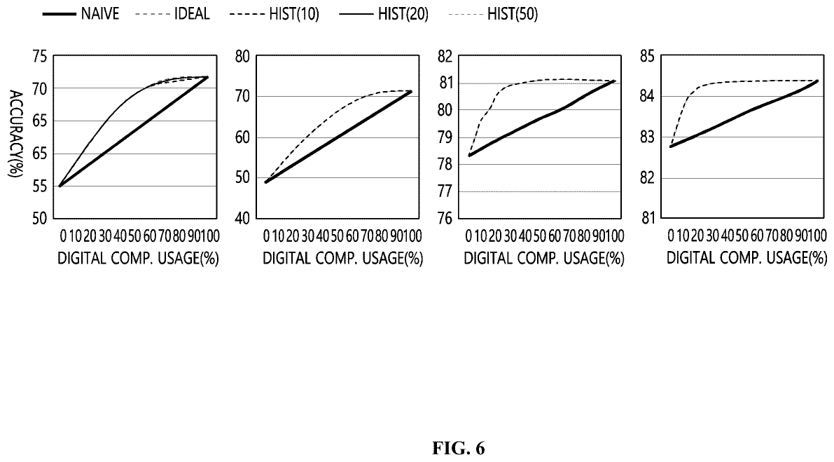

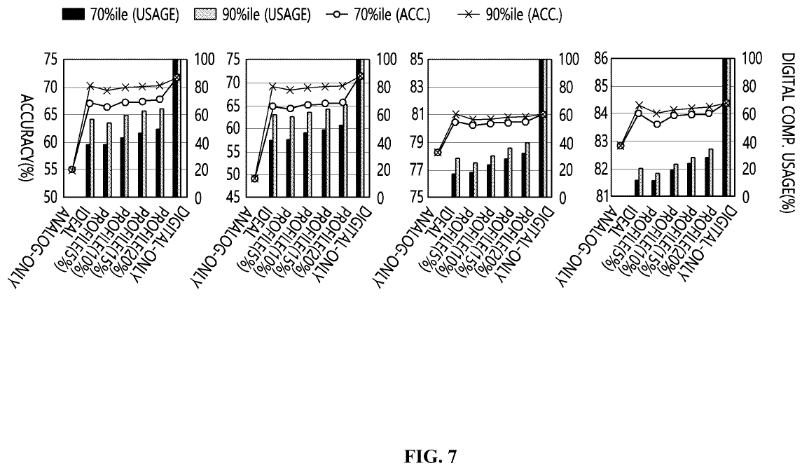

FIG. 6 is an exemplary view illustrating the performance result of a scheduling method when a digital accelerator usage rate is preset according to another embodiment.

Referring to FIG. 6, the x-axis of the graph is the usage rate of a digital accelerator set by a user, and the y-axis represents the accuracy of an AI operation. Four AI models, including Inception-v4, ResNet-18, ViT-Base, and ViT-Large, are used, and performance is measured when AI inference operations for 50,000 images are performed. For the performance evaluation, an analog accelerator simulator is modified and used.

‘Naive’ represents the performance when a user sets a digital accelerator usage rate and uses both analog and digital accelerators without applying this technique. It shows that the accuracy increases linearly with an increase in the digital accelerator usage rate.

‘Hist(#)’ represents the performance result of the proposed technique. The number in parentheses represents the number of classes (bins). It can be seen that, when the proposed technique is applied, operations may be performed without lowering the accuracy of AI operation results while maintaining the digital accelerator usage rate set by a user. ‘Ideal’ represents the performance when confidence scores for all the input data are known in advance, and it can be seen that the performance result similar to that obtained when the histogram-based method is used may be obtained.

In addition, it can be seen that the performance exhibits a similar trend when the number of histogram classes (the number of bins), which determines the precision of a histogram, is set to 10, 20, and 50, so it is confirmed that the number of bins in the histogram does not significantly affect the performance.

FIG. 7 is an exemplary view illustrating the performance result of a method for determining criteria for the use of a digital accelerator based on sampling and performing scheduling according to a further embodiment.

The same AI models and data as those used in the previous experiment are used, and the same operation is performed as in the previous experiment. The percentage of the sampling interval is set to 5% of the entire interval, and the threshold is set to the 90% ile and 70% ile values of collected confidence scores.

The gray bar graph and the line graph marked with ‘x’ at each data point represent the digital accelerator usage rate and the AI operation accuracy, respectively, when the threshold is the 90% ile value. The black bar graph and the line graph marked with ‘o’ at each data point indicate the results when the threshold is the top 70% ile value.

For reference, if the digital accelerator usage rate is low, the analog accelerator usage rate is high, which may be interpreted as high computational efficiency. ‘IDEAL’ represents the result when execution is performed on the assumption that all the results of the analog accelerator and the digital accelerator are known in advance, ‘ANALOG-ONLY’ represents the result when operations are performed using only the analog accelerator, and ‘DIGITAL-ONLY’ represents the result when operations are performed using only the digital accelerator. In the case of ‘ANALOG-ONLY’, computational efficiency is maximized, but errors in the operation increase. In the case of ‘DIGITAL-ONLY’, high accuracy is achieved thanks to digital-based operations, but computation efficiency is low and energy consumption is high. ‘PROFILE(#%)’ represents the result when the proposed technique is applied. The number in parentheses indicates the percentage of the sampling interval.

The results show that, when the method of determining criteria for using a digital accelerator based on sampling and performing scheduling is applied, it is possible to utilize the high computational efficiency of the analog accelerator while maintaining the AI operation accuracy at a high level comparable to that of the digital accelerator. When the scheduling technique is applied, the usage rate of the analog accelerator may be maintained at 38-78% while maintaining the AI operation accuracy obtainable from the use of the digital accelerator, so computational efficiency is increased.

Comparing the cases where the threshold is set to the top 70% ile and the top 90% ile of the sampled confidence scores, setting the threshold to the top 90% ile raises the proportion of modifying the operation result using the digital accelerator. As a result, the usage rate of the digital accelerator increases, but the computation accuracy may be increased. When the threshold is set to the 70% ile, the digital accelerator is relatively less used, and the computational accuracy is slightly decreased.

‘PROFILE(5%)’, ‘PROFILE(10%)’, ‘PROFILE(15%)’, and ‘PROFILE(20%)’ represent the sampling ratios set to 5, 10, 15, and 20, respectively. The higher the sampling ratio, the higher the digital accelerator usage rate used in the sampling process, which may lead to lower computational efficiency. The results show that even though the sampling ratio is not set high, there is no significant effect on the AI operation accuracy of the scheduling technique.

According to the disclosed embodiment, when AI computation is performed using an analog accelerator having superior computational performance and energy efficiency, computation errors caused due to the non-idealities of AI computation using the analog accelerator may be prevented.

Also, according to the disclosed embodiment, computation errors of an analog accelerator are compensated for using a digital accelerator while minimizing the use of the digital accelerator, whereby the utilization of the analog accelerator, which has superior performance and energy efficiency, may be maximized.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A method for scheduling analog-digital accelerators based on a softmax function value, comprising:
performing an operation on input data using an analog accelerator;
calculating a confidence score of a result of the operation performed using the analog accelerator based on softmax function values for the result of the operation performed using the analog accelerator;
determining whether to perform the operation again on the input data using a digital accelerator depending on the confidence score of the result of the operation performed using the analog accelerator; and
modifying the result of the operation performed using the analog accelerator by performing the operation again on the input data using the digital accelerator when it is determined to perform the operation again.

2. The method of claim 1, wherein the confidence score is a difference between a first value that is a largest of the softmax function values and a second value that is a second largest of the softmax function values.

3. The method of claim 1, wherein determining whether to perform the operation again comprises determining whether the calculated confidence score is less than a predetermined lower percentile in an overall confidence score distribution.

4. The method of claim 3, wherein determining whether the calculated confidence score is less than the predetermined lower percentile comprises
calculating a histogram bin including the calculated confidence score;
calculating a sum of a total number of confidence scores included in histogram bins with confidence scores lower than confidence scores within the calculated histogram bin and a value randomly selected between 0 and a count of the calculated histogram bin based on the count of the calculated histogram bin; and
determining whether a percentile of the sum in the overall confidence score distribution is less than the predetermined lower percentile in the overall confidence score distribution.

5. The method of claim 4, wherein the confidence score is cumulatively recorded in a histogram each time an operation is performed using the analog accelerator.

6. A method for scheduling analog-digital accelerators based on a softmax function value, comprising:
performing a sampling phase for determining a threshold for a confidence score in order to determine whether to modify the operation result of an analog accelerator based on a result of collecting confidence scores of results of operations performed on a predetermined number of pieces of input data using the analog accelerator; and
performing an execution phase for scheduling the analog accelerator and a digital accelerator based on a result of comparing the threshold with the confidence score calculated based on softmax function values for the results of the operations performed on the pieces of input data using the analog accelerator.

7. The method of claim 6, wherein the confidence score is a difference between a first value that is a largest of the softmax function values and a second value that is a second largest of the softmax function values.

8. The method of claim 6, wherein the sampling phase comprises
performing operations on a predetermined number of pieces of sample input data using both the analog accelerator and the digital accelerator; and
determining the threshold using confidence scores of results of the operations performed using the analog accelerator when the results of the operations performed using the analog accelerator are different from results of the operations performed using the digital accelerator.

9. The method of claim 8, wherein determining the threshold comprises setting the threshold to 0 when all the results of the operations performed using the analog accelerator are identical to the results of the operations performed using the digital accelerator.

10. The method of claim 6, wherein the execution phase comprises
performing the operation on the input data using the analog accelerator;
calculating the confidence score of the result of the operation performed using the analog accelerator based on the softmax function values for the result of the operation performed using the analog accelerator;
determining whether to perform the operation again on the input data using the digital accelerator depending on whether the confidence score of the result of the operation performed using the analog accelerator is equal to or less than the threshold; and
modifying the result of the operation performed using the analog accelerator by performing the operation again on the input data using the digital accelerator when it is determined to perform the operation again.

11. The method of claim 8, wherein
the sampling phase and the execution phase are alternately performed repeatedly, and
determining the threshold comprises reflecting the threshold calculated in a previous sampling phase at a predetermined ratio.

12. An apparatus for scheduling analog-digital accelerators based on a softmax function value, comprising:
an analog accelerator;
a digital accelerator; and
a scheduler for controlling an operation for an artificial neural network model to be performed using one of the analog accelerator and the digital accelerator,
wherein the scheduler calculates a confidence score of a result of an operation performed on input data using the analog accelerator based on softmax function values for the result of the operation performed using the analog accelerator, determines whether to perform the operation again on the input data using the digital accelerator depending on the confidence score of the result of the operation performed using the analog accelerator, and modifies, when it is determined to perform the operation again, the result of the operation performed using the analog accelerator by performing the operation again on the input data using the digital accelerator.

13. The apparatus of claim 12, wherein the confidence score is a difference between a first value that is a largest of the softmax function values and a second value that is a second largest of the softmax function values.

14. The apparatus of claim 12, wherein, when determining whether to perform the operation again, the scheduler determines whether the calculated confidence score is less than a predetermined lower percentile in an overall confidence score distribution.

15. The apparatus of claim 14, wherein, when determining whether the calculated confidence score is less than the predetermined lower percentile, the scheduler calculates a histogram bin including the calculated confidence score, calculates a sum of a total number of confidence scores included in histogram bins with confidence scores lower than confidence scores within the calculated histogram bin and a value randomly selected between 0 and a count of the calculated histogram bin based on the count of the calculated histogram bin, and determines whether a percentile of the sum in the overall confidence score distribution is less than the predetermined lower percentile in the overall confidence score distribution.

16. The apparatus of claim 15, wherein the confidence score is cumulatively recorded in a histogram each time an operation is performed using the analog accelerator.

17. The apparatus of claim 13, wherein the scheduler
sets in advance a threshold of the confidence score for determining whether to modify the result of the operation performed using the analog accelerator based on a result of collecting confidence scores of results of operations performed on a predetermined number of pieces of sample input data using the analog accelerator; and
determines whether to perform the operation again on the input data using the digital accelerator based on the threshold set in advance.

18. The apparatus of claim 17, wherein the scheduler performs the operations on the predetermined number of pieces of sample input data using both the analog accelerator and the digital accelerator and sets the threshold using the confidence scores of the results of the operations performed using the analog accelerator when the results of the operations performed using the analog accelerator are different from results of the operations performed using the digital accelerator.

19. The apparatus of claim 18, wherein the scheduler sets the threshold to 0 when all the results of the operations performed using the analog accelerator are identical to the results of the operations performed using the digital accelerator.

20. The apparatus of claim 18, wherein the scheduler sets the threshold at predetermined intervals and reflects a previously calculated threshold at a predetermined ratio.
